(19) United States
(12) Patent Application Publication
(10) Pub. No.: US 2023/0186506 A1
(43) Pub. Date: Jun. 15, 2023

(54) Object Detection Device and Object Detection Method

(71) Applicant: VIA Technologies, Inc., Taipei (TW)

(72) Inventors: Chaochin CHANG, Taipei (TW); JinBo YIN, Beijing (CN); Juan HE, Beijing (CN)

(21) Appl. No.: 17/699,467

(22) Filed: Mar. 21, 2022

(30) Foreign Application Priority Data
Dec. 14, 2021 (CN) 202111531600.7

(51) Int. Cl. G06T 7/70; G06V 10/25; G06V 10/82; G06T 7/20; G06T 3/40

(52) U.S. Cl. CPC G06T 7/70; G06V 10/25; G06V 10/82; G06T 7/20; G06T 3/40

(57) ABSTRACT

There is provided an object detection device and an object detection method. The processor of the object detection device defines respective overall image areas of a plurality of first sensed images from a plurality of original sensed images as first regions of interest; the processor defines respective partial image areas of a plurality of second sensed images from the plurality of original sensed images as second regions of interest, and crops out a plurality of third sensed images; the processor inputs the plurality of first sensed images and the plurality of third sensed images to a deep neural network learning model, so that the deep neural network learning model outputs image information of a target object image in the plurality of first sensed images and the plurality of third sensed images, respectively. By this, a function of detecting an object in front with high reliability is provided by means of image detection.

### CROSS-REFERENCE TO RELATED APPLICATION

This application claims the priority benefit of China application serial no. 202111531600.7, filed on Dec. 14, 2021. The entirety of the above-mentioned patent application is hereby incorporated by reference herein and made a part of this specification.

### TECHNICAL FIELD

The present disclosure relates to a detection technology, in particular to an object detection device and an object detection method.

### BACKGROUND

With the rapid growth of traffic flow on roads, an increase can be found in the rate of road traffic accidents year by year, especially the number of rear-end collision accidents increases year by year. Therefore, most of the traditional vehicles are equipped with a distance detection apparatus, such as a radar, to detect surrounding obstacles and provide a forward distance detection function. However, the traditional distance detection apparatus solely provides a simple function of distance sensing, and it cannot provide richer information, such as an object type and a motion state of the target object. Traditional distance detection apparatuses also have the disadvantages of being susceptible to misjudgment and of high setup cost.

### SUMMARY

The present disclosure provides an object detection device and an object detection method, which provide a function of detecting an object in front with high reliability by means of image detection.

An object detection device of the present disclosure includes a camera, a storage unit and a processor. The camera obtains consecutively a plurality of original sensed images. The storage unit stores a plurality of modules. The processor is coupled to the storage unit, and executes the plurality of modules, to: define respective overall image areas of a plurality of first sensed images from the plurality of original sensed images as first regions of interest; define respective partial image areas of a plurality of second sensed images from the plurality of original sensed images as second regions of interest, and crop out a plurality of third sensed images based on respective second regions of interest of the plurality of second sensed images; input the plurality of first sensed images and the plurality of third sensed images to a deep neural network learning model, so that the deep neural network learning model outputs image information of a target object image in the plurality of first sensed images and the plurality of third sensed images, respectively; and obtain an actual distance to a target object in the target object image based on the image information of the target object image.

The object detection method of the present disclosure includes the following steps: obtaining a plurality of original sensed images by a camera; defining, by a processor, respective overall image areas of a plurality of first sensed images from the plurality of original sensed images as first regions of interest; defining, by the processor, respective partial image areas of a plurality of second sensed images from the plurality of original sensed images as second regions of interest, and cropping out a plurality of third sensed images based on respective second regions of interest of the plurality of second sensed images; inputting, by the processor, the plurality of first sensed images and the plurality of third sensed images to a deep neural network learning model, so that the deep neural network learning model outputs image information of a target object image in the plurality of first sensed images and the plurality of third sensed images, respectively; and obtaining an actual distance to a target object in the target object image based on the image information of the target object image.

On this basis, the object detection device and the object detection method of the present disclosure can perform image processing and image analysis on the sensed images provided by the camera, to obtain position information and image size of the target object image.

In order to make the above-mentioned features and advantages of the present disclosure more obvious and easy to understand, the following specific embodiments are described below in detail in combination with the drawings.

### BRIEF DESCRIPTION OF THE DRAWINGS

FIG. 1 shows a diagram of a circuit for an object detection device according to an embodiment of the present disclosure.

FIG. 2 shows a flow chart of an object detection method according to an embodiment of the present disclosure.

FIG. 3 shows a diagram of sensed images according to an embodiment of the present disclosure.

FIG. 4 shows a diagram of a cropped sensed image according to an embodiment of the present disclosure.

FIG. 5 shows a diagram of analyzing an object image in a sensed image according to an embodiment of the present disclosure.

FIG. 6 shows a flow chart for calculating horizon height coordinates in a sensed image according to an embodiment of the present disclosure.

FIG. 7 shows a flow chart for calculating an actual distance to an object according to an embodiment of the present disclosure.

The numerical references in the drawings are given below.

100: object detection device; 110: processor; 120: storage unit; 121: deep neural network learning model; 130: camera; 300_1˜300_N, 301_1˜301_N, 302_1˜302_M, 303, 303_1˜303_P, 304_1˜304_P, 505: sensed image; 506: target object image; Wc, Wf, Wo: width; Hc, Hf, Ho, Yh: height; I1, I2: region of interest; S210˜S250, S610˜S630, S710˜S720: step.

### DETAILED DESCRIPTION

In order to make the content of the present disclosure more comprehensible, the following embodiments are given as examples according to which the present disclosure can actually be implemented. Additionally, where possible, elements/components/steps with the same numerical references are used in the drawings and embodiments to represent the same or similar parts.

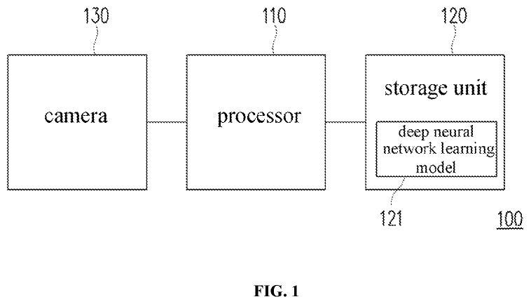

FIG. 1 is a diagram of a circuit for an object detection device according to an embodiment of the present disclosure. Referring to FIG. 1, the object detection device 100 includes a processor 110, a storage unit 120 and a camera 130. The storage unit 120 may store a deep neural network learning model 121 and a plurality of modules. The processor 110 is coupled to the storage unit 120 and the camera 130. In the embodiment, the object detection device 100 is adapted to be positioned at the front of a vehicle (e.g., positioned at the head of the vehicle) to provide a function of detecting an object in front of the vehicle (e.g., detection of another vehicle in front), but the disclosure is not limited thereto. In the embodiment, the camera 130 may consecutively obtain a plurality of original sensed images. The processor 110 may receive the plurality of original sensed images, and execute the deep neural network learning model 121 and other modules to perform image processing and image analysis on the plurality of sensed images. The object detection device 100 may identify the object image in the sensed images, and may obtain position information and image size of the object image, a type of the object and an actual distance to the object.

In the embodiment, the processor 110 may be a processing circuit or a control circuit, such as a Central Processing Unit (CPU), a Microprocessor Control Unit (MCU), a Field Programmable Gate Array (FPGA) and the like, and the present disclosure is not limited thereto. In the embodiment, the storage unit 120 may be, for example, a memory, and is used to store the deep neural network learning model 121, other related modules, image data, and related software program or algorithms for the processor 110 to access and execute. The camera 130 may be a CMOS Image Sensor (CIS) camera or a Charge Coupled Device (CCD) camera.

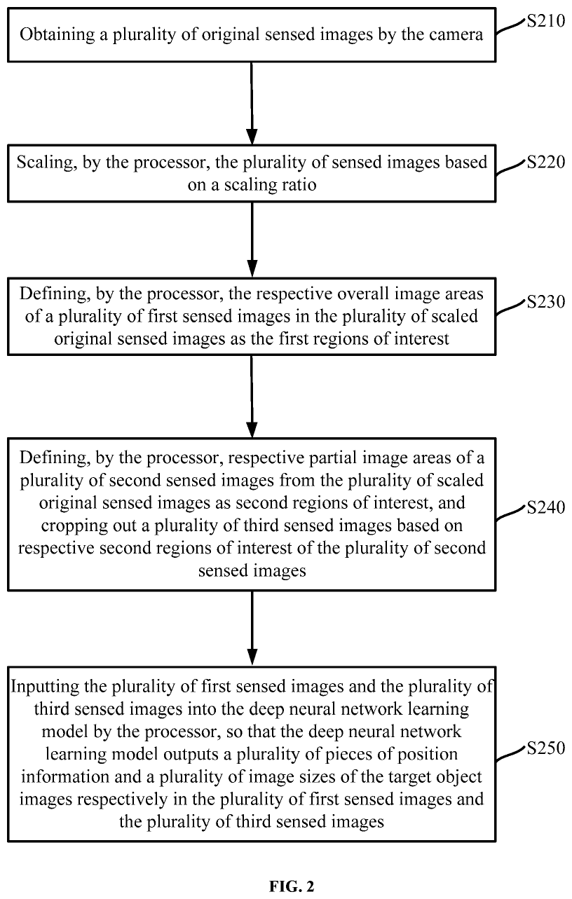

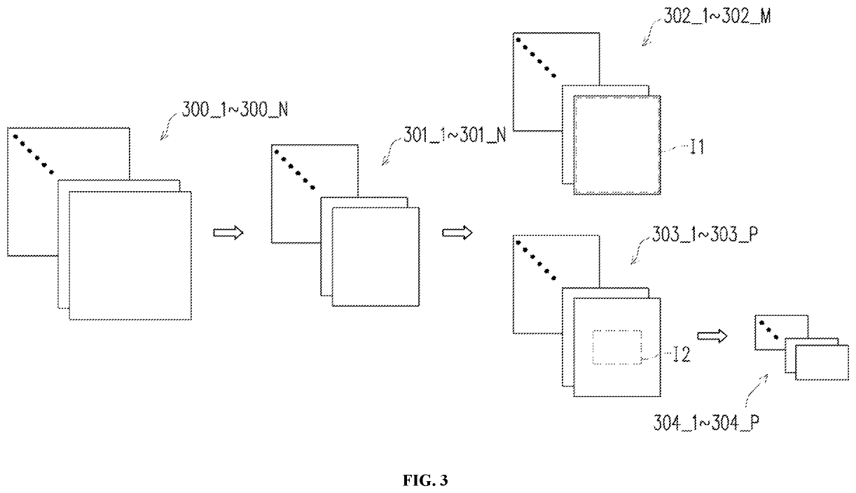

FIG. 2 is a flowchart of an object detection method according to an embodiment of the present disclosure. FIG. 3 is a diagram of sensed images according to an embodiment of the present disclosure. Referring to FIG. 1 to FIG. 3, the object detection device 100 may perform the following steps S210 to S250 to realize a function of object detection. In step S210, the object detection device 100 may consecutively obtain a plurality of original sensed images 300_1˜300_N with the camera 130, wherein N is a positive integer. In step S220, the object detection device 100 may scale, by the processor 110, the plurality of sensed images 300_1˜300_N based on a scaling ratio r, so as to generate a plurality of scaled sensed images 301_1˜301_N. In the embodiment, the image size of the original sensed images 300_1˜300_N may be, for example, 1920×1080 (pixels), and the image size of the scaled sensed images 301_1˜301_N may be, for example, 1024×576 (pixels). However, the image size of the original sensed images and scaling ratio r in the present disclosure are not limited to this. In an embodiment, the scaling ratio r may be, for example, 0.5. Or, in another embodiment, the object detection device 100 may not scale the original sensed images 300_1˜300_N (i.e., the scaling ratio r may be set to 1).

In step S230, by the processor 110, the object detection device 100 may define the respective overall image areas of a plurality of first sensed images 302_1˜302_M in the plurality of scaled original sensed images 301_1˜301_N as the first regions of interest I1, where M is a positive integer. In step S240, with the processor 110, the object detection device 100 may define the respective partial image areas of a plurality of second sensed images 303_1˜303_P in the plurality of scaled original sensed images 301_1˜301_N as the second regions of interest I2, and a plurality of third sensed images 304_1˜304_P are cropped out based on the respective second regions of interest I2 of the plurality of second sensed images 303_1˜303_P, wherein P is a positive integer. The second region of interest I2 may be, for example, a predetermined region positioned at the center of the sensed image, so that the object detection device 100 may focus on a target object directly in front of the camera 130.

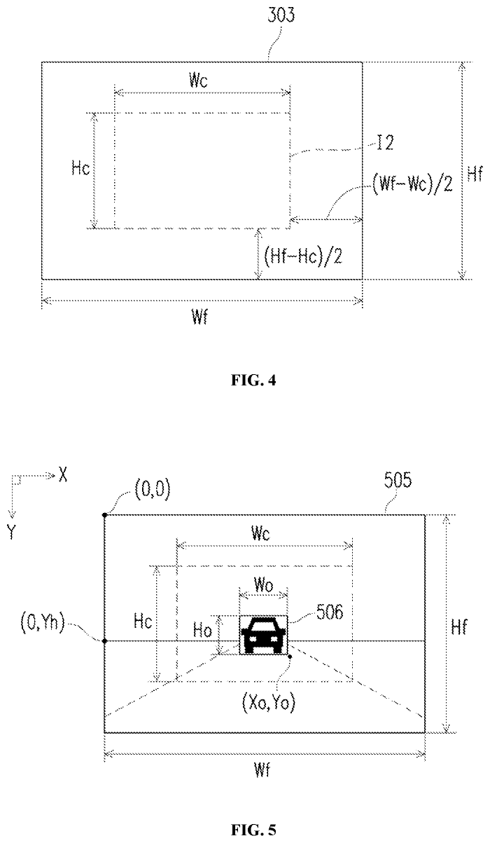

Referring to FIG. 4, FIG. 4 is a diagram of a cropped sensed image according to an embodiment of the present disclosure. For example, the second sensed image 303 (which is collective reference to 303_1 to 303_P hereinafter) may have, for example, an image size of width Wf×height Hf (in pixels), and the second region of interest I2 may have, for example, an image size of width Wc×height Hc (in pixels). In this regard, the distance between the lower edge of the second region of interest I2 and the lower image boundary of the second sensed image 303 and the distance between the upper edge of the second region of interest I2 and the upper image boundary of the second sensed image 303 are both (Hf−Hc)/2. The distance between the left edge of the second region of interest I2 and the left image boundary of the second sensed image 303 and the distance between the right edge of the second region of interest I2 and the right image boundary of the second sensed image 303 are both (Wf−Wc)/2. Therefore, the processor 110 may crop the second sensed image 303 based on the aforementioned image size parameters and the distance parameters, to generate a corresponding third sensed image. However, the position and range of the second region of interest I2 of the present disclosure are not limited to the foregoing examples. In an embodiment, the second region of interest I2 may be cropped out from other regions of an overall image, for example, based on different object detection requirements.

In the embodiment, the first sensed images 302_1˜302_M may be, for example, images of odd frames in the plurality of scaled original sensed images 301_1˜301_N, and the second sensed images 303_1˜303_P may be, for example, images of even frames in the plurality of scaled original sensed images 301_1 to 301_N. In other words, the images of odd frames retain the full size of the image area in order to reduce the loss of key information in the image when the distance to the target object in front (for example, a large truck) is relatively close, so as to obtain an image of a complete outline of the object as much as possible. However, in an embodiment, based on different object detection requirements, the mentioned images of the odd frames and images of the even frames may be respectively cropped out from the plurality of scaled original sensed images 301_1˜301_N based on two regions of interest with different sizes. In another embodiment, the processor 110 may further divide the plurality of scaled original sensed images 301_1˜301_N into more groups (for example, dividing into 3 groups corresponding to: the 1st, 4th, 7th, . . . frames, the 2nd, 5th, 8th, . . . frames, and the 3rd, 6th, 9th, . . . frames, respectively) based on more settings of the region of interest (for example, three or more different regions of interest), for cropping out the sensed images, and is not limited to the aforementioned division into odd frames and even frames.

Next, before the plurality of first sensed images 302_1˜302_M and the plurality of third sensed images 304_1˜304_P are input to the deep neural network learning model 121, the processor 110 may firstly adjust the plurality of first sensed images 302_1˜302_M and the plurality of third sensed images 304_1˜304_P to the same image size, and then input them to the deep neural network learning model 121. In an embodiment, for example, the plurality of first sensed images 302_1˜302_M and the plurality of third sensed images 304_1˜304_P may be uniformly reduced to a pixel area size of 512×288 (pixels), but the present disclosure is not limited to this.

In step S250, the object detection device 100 may input the plurality of first sensed images 302_1˜302_M and the plurality of third sensed images 304_1˜304_P into the deep neural network learning model 121 by the processor 110, so that the deep neural network learning model 121 outputs a plurality of position information and a plurality of image sizes of the target object images respectively in the plurality of first sensed images 302_1˜302_M and the plurality of third sensed images 304_1˜304_P. There may be one or more target objects in each of the first sensed images 302_1˜302_M and each of the third sensed images 304_1˜304_P. In the embodiment, the deep neural network learning model 121 may be pre-trained to have the ability to recognize the target object image in the images, and may output the image information of the target object image in each sensed image, including for example the position information and the image size. It should be noted that the position information may be coordinates of one vertex of the target object image in the respective sensed image, and the image size may be the width and the height of the target object image in the respective sensed image. In an embodiment, the deep neural network learning model 121 may use the Mobilenet SSD model, but the present disclosure is not limited to this.

For example, referring to FIG. 5, FIG. 5 is a diagram of analyzing an object image in a sensed image according to an embodiment of the present disclosure. FIG. 5 takes one target object image in the sensed image as an example, but in other embodiments, there may also be multiple target object images in the sensed image at the same time. The processor 110 can identify the target object image 506 in the sensed image 505. In an example where the region of interest is a complete image area with a range of (Wf×Hf), the output result of the deep neural network learning model 121 gives the coordinates of the vertex of the target object image 506 in the sensed image 505 as (Xo, Yo)=(x×Wf, y×Hf), wherein the coordinate origin (0, 0) is the upper left corner of the sensed image 505. The width of the target object image 506 in the sensed image 505 is Wo=w×Wf, and the height is Ho=h×Hf. In an example where the region of interest is an area of Wc×Hc cropped out from the middle of a complete image area, the output result of the deep neural network learning model 121 gives the coordinates of the vertex of the target object image 506 in the sensed image 505 as (Xo, Yo)=(x×Wc+(Wf−Wc)/2, y×Hc+(Hf−Hc)/2). The width of the target object image 506 in the sensed image 505 is Wo=w×Wc, and the height is Ho=h×Hc.

That is, the deep neural network learning model 121 outputs image information (x, y, w, h) respectively for each target object image identified in the plurality of first sensed images 302_1˜302_M and the plurality of third sensed images 304_1˜304_P, where (x, y) may correspond to the normalized position information of the target object image in the sensed image, and (w, h) may correspond to the normalized image size of the target object image in the sensed image. Therefore, the processor 110 may obtain the position information and the image size of each target object image in the sensed image according to the above formulas. That is, the processor 110 may calculate respectively, according to the above formulas, the position information and image size in the scaled original sensed images 301_1˜301_N for each target object image in the first sensed images 302_1˜302_M and the third sensed images 304_1˜304_P.

In addition, in an embodiment, the image information output by the deep neural network learning model 121 may further include a type of respective target object (such as a small car or a truck) in the plurality of first sensed images 302_1˜302_M and the plurality of third sensed images 304_1˜304_P. In addition, in another embodiment, the processor 110 may further execute an image tracking module to track a respective target object image in the plurality of first sensed images 302_1˜302_M and the plurality of third sensed images 304_1˜304_P, so that the target object image can be detected stably, and the reliability of the detection result can be enhanced. The image tracking module may be stored in the storage unit 120, and the image tracking module may, for example, use the Lucas-Kanade optical flow algorithm, but the disclosure is not limited thereto. In yet another embodiment, the processor 110 may also execute an image smoothing module to detect the position and size of a respective target object image in the first sensed images and the third sensed images respectively, so as to smooth the detected positions and sizes of the target object images in the plurality of sensed images, and on this basis, stable position, height and width of the target object image, and the information of the type of the target object can be obtained. The image smoothing module may be stored in the storage unit 120, and the image smoothing module may, for example, use Kalman filtering algorithm, but the present disclosure is not limited thereto.

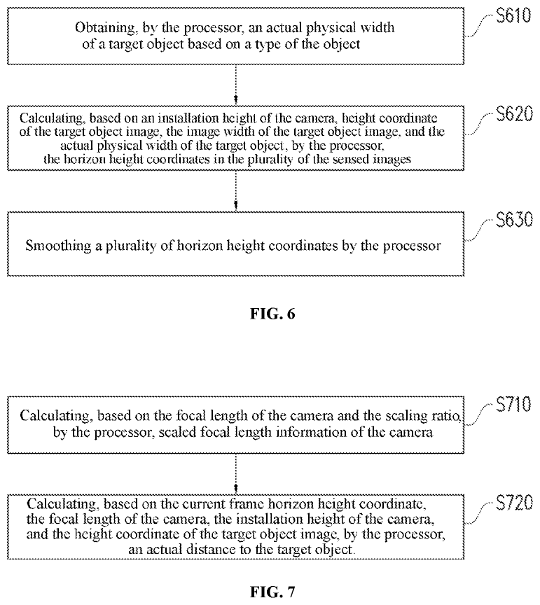

FIG. 6 is a flowchart for calculating horizon height coordinates in a sensed image according to an embodiment of the present disclosure. By referring to FIG. 1, FIG. 5 and FIG. 6, and after the above step S250, the object detection device 100 may perform the following steps S610 to S630 on each of the scaled original sensed images 301_1˜301_N to calculate the horizon height coordinates in each of scaled original sensed images 301_1˜301_N. In step S610, the object detection device 100 may obtain, by the processor 110, an actual physical width of a respective target object based on the type of the target object in the sensed image. For example, if the type of the target object is a small family car, the processor 110 may obtain the actual physical width (empirical value Wp) of the target object as 260 centimeters (cm). If the type of the target object is a mini family car, the processor 110 may obtain the actual physical width (empirical value Wp) of the target object as 180 cm. Alternatively, if the type of the target object is a medium truck, the processor 110 may obtain the actual physical width (empirical value Wp) of the target object as 300 cm. If the type of the target object is a large truck, the processor 110 may obtain the actual physical width (empirical value Wp) of the target object as 350 cm.

In step S620, the object detection device 100 may calculate, based on an installation height (Hc) (in cm) of the camera 130, bottom height coordinate (Yo) of the respective target object image, the image width (Wo) of the respective target object image, and the actual physical width (Wp) of the respective target object, by the processor 110, the corresponding horizon height coordinate Yh (in pixels) for a respective target object image in the sensed image. In the embodiment, the processor 110 may use the following formula (1) to obtain the horizon height coordinate Yh corresponding to a respective target object image.

Yh≤Yo−Hc×Wo/Wp (1)

In step S630, the object detection device 100 may smooth a plurality of horizon height coordinates by the processor 110; for example, the respective horizon height coordinates corresponding to each target object image in the sensed images may be smoothed, and the horizon height coordinates in the plurality of sensed images (for example, the sensed images of the preceding and following frames) may be further smoothed, to eliminate errors in the calculated horizon positions corresponding to the respective target objects. In the embodiment, the smoothing may, for example, use information such as the calculated horizon positions corresponding to a plurality of target object images or the horizon positions for the scaled original sensed images of the preceding and following frames, for operations such as arithmetic average operations or weighted average operations on the obtained horizon height coordinates from the above Formula (1), to obtain the current frame horizon height coordinate Yh_f.

FIG. 7 shows a flow chart for calculating an actual distance to the object according to an embodiment of the present disclosure. By referring to FIG. 1, FIG. 5 and FIG. 7, and after the above step S630, the object detection device 100 may perform the following steps S710 to S720 to calculate the actual distance to a respective target object in the sensed image. In step S710, the object detection device 100 may calculate, based on a focal length F of the camera 130 and the aforementioned scaling ratio r, by the processor 110, a scaled focal length information of the camera 130. In the embodiment, the processor 110 may, for example, perform an operation of the following Formula (2) to obtain the scaled focal length information (F′) of the camera 130 (in pixels).

F′=F×r (2)

In step S720, the object detection device 100 can calculate, based on the current frame horizon height coordinate Yh_f, the scaled focal length information (F′) of the camera 130, the installation height (Hc) of the camera 130, and the bottom height coordinate (Yo) of the respective target object image, by the processor 110, an actual distance (d) to the respective target object (in cm). In the embodiment, the processor 110 may, for example, perform the operation of the following Formula (3) to obtain the actual distance (d) to the respective target object.

d=F′×Hc/(Yo−Yh_f) (3)

However, in an embodiment, the object detection device 100 may also obtain the actual distance (d) without the above procedures in FIG. 6 and FIG. 7. By taking an example of the camera 130 mounting on a vehicle, if the cameras 130 are uniformly installed at a fixed position on vehicles of the same design (for example, if the object detection device 100 is uniformly installed by the vehicle manufacturer), the parameters such as the focal length and the installation position of the camera 130 are all fixed. Therefore, the processor 110 may also measure/correct correspondence relationships between the actual distance (d) and the image width (Wo) of the target object image or/and the bottom height coordinate (Yo) of the target object image directly during the manufacture of the vehicles; for example, a lookup table may be established based on the correspondence relationships. In this way, the processor 110 may search the lookup table based on at least one of the bottom height coordinate (Yo) of the target object image and the image width (Wo) of the target object image, so as to directly obtain the actual distance (d) to the target object.

In summary, the object detection device and the object detection method of the present disclosure may be effectively applied on a vehicle to detect another vehicle in front by means of a real-time image detection, to provide highly reliable functions of front object detection and distance detection. In addition, the object detection device and object detection method of the present disclosure may also be used in an Advanced Driving Assistant System (ADAS) (such as a Forward Collision Warning (FCW) system), to provide functions of driving assistance and collision warning. The present disclosure also has an advantage in small calculation amount and does not depend on calibrations, which is suitable for the calculation capability of an on-board system, and can meet the real-time requirements for object detection.

The above descriptions are only preferred embodiments of the present disclosure, but they are not intended to limit the scope of the present disclosure. Without departing from the spirit and scope of the present disclosure, one in the art can make further modifications and changes on this basis. Therefore, the protection scope of the present disclosure shall be subject to the scope defined by the claims.

What is claimed is:

1. An object detection device, comprising:
a camera configured to obtain a plurality of original sensed images;
a storage unit configured to store a plurality of modules; and
a processor coupled to the storage unit, configured to execute the plurality of modules, to:
define respective overall image areas of a plurality of first sensed images from the plurality of original sensed images as first regions of interest;
define respective partial image areas of a plurality of second sensed images from the plurality of original sensed images as second regions of interest, and crop out a plurality of third sensed images based on respective second regions of interest of the plurality of second sensed images;
input the plurality of first sensed images and the plurality of third sensed images to a deep neural network learning model, so that the deep neural network learning model outputs image information of a target object image in the plurality of first sensed images and the plurality of third sensed images, respectively; and
obtain an actual distance to a target object in the target object image based on the image information of the target object image.

2. The object detection device according to claim 1, wherein the processor is configured to adjust the plurality of first sensed images and the plurality of third sensed images to a same image size, and input the first sensed images and the third sensed images after being adjusted to the deep neural network learning model.

3. The object detection device according to claim 1, wherein the second region of interest is a partial image area at a center of the plurality of second sensed images.

4. The object detection device according to claim 1, wherein the processor is configured to execute an image tracking module to track the target object image in the plurality of first sensed images and the target object image in the plurality of third sensed images, respectively.

5. The object detection device according to claim 1, wherein the plurality of first sensed images and the plurality of second sensed images are respectively sensed images of odd frames and sensed images of even frames in the plurality of original sensed images.

6. The object detection device according to claim 1, wherein the image information includes image size and position information of the target object image in the plurality of first sensed images and image size and position information of the target object image in the plurality of third sensed images.

7. The object detection device according to claim 6, wherein the image information further includes a type of the target object in the target object image in the plurality of first sensed images and in the plurality of third sensed images.

8. The object detection device according to claim 7, wherein the processor is configured to obtain an actual physical width of the target object based on the type, and calculate a horizon height coordinate corresponding to the target object image based on an installation height of the camera, a height coordinate of the target object image, an image width of the target object image, and the actual physical width of the target object.

9. The object detection device according to claim 8, wherein the processor is configured to smooth horizon height coordinates corresponding to a plurality of target object images to obtain a current frame horizon height coordinate.

10. The object detection device according to claim 9, wherein the processor is configured to calculate the actual distance to the target object based on the current frame horizon height coordinate, a focal length of the camera, the installation height of the camera, and the height coordinate of the target object image.

11. An object detection method, comprising:
obtaining a plurality of original sensed images by a camera;
defining respective overall image areas of a plurality of first sensed images from the plurality of original sensed images as first regions of interest;
defining respective partial image areas of a plurality of second sensed images from the plurality of original sensed images as second regions of interest, and cropping out a plurality of third sensed images based on respective second regions of interest of the plurality of second sensed images;
inputting the plurality of first sensed images and the plurality of third sensed images to a deep neural network learning model, so that the deep neural network learning model outputs image information of a target object image in the plurality of first sensed images and the plurality of third sensed images, respectively; and
obtaining an actual distance to a target object in the target object image based on the image information of the target object image.

12. The object detection method according to claim 11, wherein said inputting the plurality of first sensed images and the plurality of third sensed images to a deep neural network learning model comprises:
adjusting the plurality of first sensed images and the plurality of third sensed images to a same image size, and inputting the first sensed images and the third sensed images after being adjusted to the deep neural network learning model.

13. The object detection method according to claim 11, wherein the second region of interest is a partial image area at a center of the plurality of second sensed images.

14. The object detection method according to claim 11, wherein said inputting the plurality of first sensed images and the plurality of third sensed images to a deep neural network learning model comprises:
executing an image tracking module to track the target object image in the plurality of first sensed images and the target object image in the plurality of third sensed images, respectively.

15. The object detection method according to claim 11, wherein the plurality of first sensed images and the plurality of second sensed images are respectively sensed images of odd frames and sensed images of even frames in the plurality of original sensed images.

16. The object detection method according to claim 11, wherein the image information includes image size and position information of the target object image in the plurality of first sensed images and image size and position information of the target object image in the plurality of third sensed images.

17. The object detection method according to claim 16, wherein the image information further includes a type of the target object in the target object image in the plurality of first sensed images and in the plurality of third sensed images.

18. The object detection method according to claim 17, further comprising:
obtaining an actual physical width of the target object based on the type, and
calculating a horizon height coordinate corresponding to the target object image based on an installation height of the camera, a height coordinate of the target object image, an image width of the target object image, and the actual physical width of the target object.

19. The object detection method according to claim 18, further comprising:
smoothing horizon height coordinates corresponding to a plurality of target object images to obtain a current frame horizon height coordinate.

20. The object detection method according to claim 19, further comprising:
calculating the actual distance to the target object based on the current frame horizon height coordinate, a focal length of the camera, the installation height of the camera, and the height coordinate of the target object image.
